(19) United States
(12) Patent Application Publication
(10) Pub. No.: US 2012/0093407 A1
(43) Pub. Date: Apr. 19, 2012

(54) OBJECT DETECTION AND CLASSIFICATION METHOD AND APPARATUS

(75) Inventors: Shuqi MEI, Beijing (CN); Weiguo WU, Beijing (CN)

(73) Assignee: Sony Corporation, Tokyo (JP)

(21) Appl. No.: 13/238,303

(22) Filed: Sep. 21, 2011

(30) Foreign Application Priority Data
Sep. 21, 2010 (CN) 201010292493.2

(51) Int. Cl. G06K 9/62

(52) U.S. Cl. 382/170; 382/225

(57) ABSTRACT

An object detection and classification method and apparatus, the method includes: inputting an image; performing window scan on the image to make, for each class, object existence decision on each window, and making, on a window of which the decision is positive, an object class decision to obtain an object classification confidence of the window; performing, for all classes, spatial neighborhood merging on all windows with positive result of object existence decision to obtain merged regions and object detection confidences thereof; judging, for each merged region, whether the object detection confidence of the merged region is higher than a predetermined threshold; calculating, for each class, if higher than the predetermined threshold, a merged object classification confidence for all the windows with positive result of object existence decision within the merged region; and determining a class with a highest merged object classification confidence as the class of the merged region.

### FIELD OF THE INVENTION

The present invention relates to the field of computer vision and image processing, and more particularly to an object detection and classification method and apparatus.

### BACKGROUND OF THE INVENTION

It becomes more and more important to perform object data detection and classification on an image or other data to be detected utilizing a machine learning method, and particularly detection and classification on objects in the image has become an important branch thereof.

In the prior art, it is a common way to first detect regions which contain the object data in the image and then to determine classes of which these object data is. Thus, an alignment operation needs to be performed when performing classification, thereby significantly increasing the calculation amount of object detection and classification, and in a case that the alignment operation is not accurate, the accuracy of the object detection and classification may be decreased severely.

### SUMMARY OF THE INVENTION

The summary of the invention will be given below to provide basic understanding of some aspects of the invention. It shall be appreciated that this summary is neither exhaustively descriptive of the invention nor intended to define essential or important parts or the scope of the invention, but is merely for the purpose of presenting some concepts of the invention in a simplified form and hereby acts as a preamble of detailed description which will be discussed later.

In view of the above circumstances in the prior art, an object of the invention is to provide an object detection and classification method which may efficiently reduce the calculation amount of the object detection and classification and improve the accuracy thereof.

To achieve the above object, according to one aspect of the invention, there is provided an object detection and classification method including: inputting an image to be processed; performing window scan on the image to make, for each class, object existence decision of whether an object of this class exists on each window, and then making, on a window of which the decision is positive, an object class decision of whether this window is of this class or other classes, so as to obtain an object classification confidence of the window with respect to this class; performing, for all classes, spatial neighborhood merging on all windows with positive result of object existence decision to obtain one or more merged regions and object detection confidences thereof; judging, for each merged region, whether the object detection confidence of the merged region is higher than a predetermined threshold; calculating, for each class, a merged object classification confidence for all the windows with positive result of object existence decision within the merged region, if the object detection confidence of the merged region is higher than the predetermined threshold; and determining a class with a highest merged object classification confidence as the class of the merged region.

According to another aspect of the invention, there is further provided an object detection and classification apparatus, which includes: an input unit configured to input an image to be processed; a window scan unit configured to perform window scan on the image to make, for each class, object existence decision of whether an object of this class exists on each window, and then make, on a window of which the decision is positive, an object class decision of whether this window is of this class or other classes, so as to obtain an object classification confidence of the window with respect to this class; a spatial neighborhood merging unit configured to perform, for all classes, spatial neighborhood merging on all windows with positive result of object existence decision to obtain one or more merged regions and object detection confidences thereof; a judgment unit configured to judge, for each merged region, whether the object detection confidence of the merged region is higher than a predetermined threshold; a merged confidence calculation unit configured to calculate, for each class, a merged object classification confidence for all the windows with positive result of object existence decision within the merged region, if the object detection confidence of the merged region is higher than the predetermined threshold; and a class determination unit configured to determine a class with a highest merged object classification confidence as the class of the merged region.

According to still another aspect of the invention, there is further provided a computer program product for implementing the object detection and classification method described above.

According to yet another aspect of the invention, there is further provided a computer-readable medium on which computer program codes for implementing the object detection and classification method described above are recorded.

According to the foregoing technical solutions of the invention, as compared with the prior art, since the alignment operation required for object classification is avoided, it is possible to efficiently reduce the calculation amount of object detection and classification and improve the accuracy thereof.

### BRIEF DESCRIPTION OF THE DRAWINGS

The invention can be better understood with reference to the detailed description given below in conjunction with the accompanying drawings, throughout which identical or similar components are denoted by identical or similar reference signs, and together with which the following detailed description are incorporated into and form a part of the specification and serve to further illustrate preferred embodiments of the invention and to explain principles and advantages of the invention. In the drawings:

FIG. 1 illustrates an overall flowchart of an object detection and classification method according to an embodiment of the invention;

FIG. 2 illustrates an example graph of spatial neighborhood merging processing in the spatial neighborhood merging step as shown in FIG. 1;

FIG. 3 illustrates a structural block diagram of an object detection and classification apparatus according to an embodiment of the invention; and

FIG. 4 illustrates an exemplary structural block diagram of a computer in which the present invention is implemented.

Those skilled in the art will appreciate that elements in the Figures are illustrated merely for simplicity and clarity and not necessarily drawn to scale. For example, the dimensions of some of the elements in the Figures may be scale up relative to other elements so as to improve understanding of the embodiments of the present invention.

### DETAILED DESCRIPTION OF THE INVENTION

Exemplary embodiments of the present invention will be described in conjunction with the accompanying drawings hereinafter. For the sake of clarity and conciseness, not all the features of actual implementations are described in the specification. However, it shall be appreciated that, during developing any of such actual implementations, numerous implementation-specific decisions must be made to achieve the developer's specific goals, for example, compliance with system-related and business-related constraints which will vary from one implementation to another. Moreover, it is also to be appreciated that, such a development effort might be very complex and time-consuming, but may nevertheless be a routine task for those skilled in the art having the benefit of this disclosure.

It shall further be noted that only those apparatus structures and/or processing steps closely relevant to solutions of the invention will be illustrated in the drawings while omitting other details less relevant to the invention so as not to obscure the invention due to those unnecessary details.

Firstly, an object detection and classification method according to an embodiment of the invention will be described in detail with reference to the drawings.

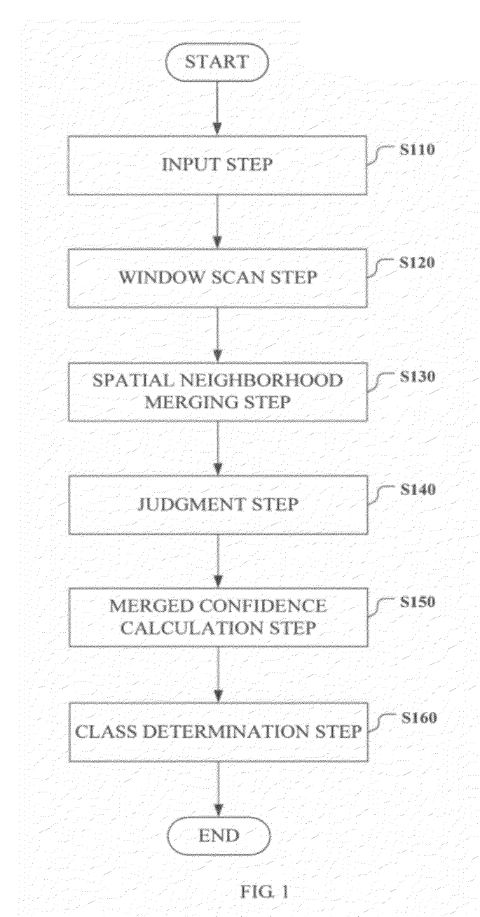

FIG. 1 illustrates an overall flowchart of an object detection and classification method according to an embodiment of the invention. As shown in FIG. 1, the object detection and classification method according to the embodiment of the invention includes an input step S110, a window scan step S120, a spatial neighborhood merging step S130, a judgment step S140, a merged confidence calculation step S150 and a class determination step S160.

First, in the input step S110, an image to be processed is input. Here, the image to be processed may be any given image or an image intercepted from a video.

Next, in the window scan step S120, the window scan is performed on the image to make, for each class, object existence decision of whether an object of this class exists on each window, and then an object class decision of whether this window is of this class or other classes is made on a window of which the decision is positive, so as to obtain an object classification confidence of the window with respect to this class.

For example, in an application scene of vehicle detection and classification, assuming that predetermined classes include three classes of car, bus and truck, then for each class, first it is decided whether each window contains an image of this class of vehicle (e.g., for the class of car, an object existence decision of car/background is performed), and then the object class decision is performed on the window which is decided to contain the image of this class of vehicle (e.g., for the class of car, a class decision of car class/non-car class is performed). It shall be appreciated that the embodiments of the invention are not limited to detection and classification on the vehicles in an image and/or video, but other objects such as faces with multiple angles in the image and/or video can be detected and classified.

Further, it shall be understood that processing of the object existence decision and the object class decision performed here may be implemented by employing any detection and classification techniques in the prior art, such as Boosting classification, cascade classification and the like.

Additionally, in the window scan step S120, the window scan on the image may be performed utilizing a predetermined window and step. In one example, the window may be a rectangular window, the size of which may be determined depending on practical requirements. The step may also be determined depending on practical requirements, for example, the step may be one or more pixels, and may be in proportion to the size of the current window. The order and manner for performing the scan may also be arbitrary, e.g., from left to right and from up to down or from right to left and from down to up. There is no limitation to this in the present invention.

Furthermore, preferably, in the window scan step S120, it is possible to perform multi-scale window scan on the image due to an uncertainty of the scale of the detection object. The multi-scale window scan may adopt a mode WinScanMode1 (i.e., the image is scanned with a window of a selected fixed size, the size of the image is reduced or enlarged to a scale after the scan is finished, and the image is scanned again with the window of the fixed size) or a mode WinScanMode2 (i.e., while keeping the size of the image constantly, the size of the window for the first scan is selected, and the size of the window is reduced or enlarged to a scale after the scan is finished, and again the original image is traversed). For example, such a multi-scale scan technique is disclosed in the Chinese patent application No. 200910132668.0 titled “DETECTION APPARATUS AND DETECTION METHOD FOR MULTIPLE CLASSES OF OBJECTS” filed by the present applicant on Apr. 1, 2009, which is hereby incorporated by reference in its entirety.

Further, preferably, in the window scan step S120, no sample is rejected in an object class decision for a window which is decided to be positive, that is to say, in a case that the window is decided to be not of the current class, the previous detection result is not rejected, such that the object class decision result may not influence the previous detection result, thus ensuring the accuracy of the object detection.

Next, in the spatial neighborhood merging step S130, spatial neighborhood merging on all windows with positive result of object existence decision is performed for all classes, so as to obtain one or more merged regions and object detection confidences thereof. That is, for each window in the above window scan step S120, the window would be involved in the spatial neighborhood merging processing as long as it is decided to be positive in the object detection processing for a certain class.

Specifically, in the course of the scan, the detection object may be caused to cross a plurality of windows due to various reasons (for example, the size of the detection object is larger than that of the window, or the step of the window scan is smaller than the size of the detection object, or simply because the position of the detection object itself just cross the boundary of the window), thus causing the plurality of windows to have positive responses (i.e. positive result of object existence decision) to the detection object. To this end, it is possible to merge the neighboring windows with positive responses to obtain the position of the merged region and the object detection confidence thereof.

Here, the above spatial neighborhood merging processing may be achieved by a clustering processing in the prior art, for example, k-means clustering algorithm and the like. It shall be appreciated that the method for spatial neighborhood merging processing described herein is merely exemplary, but not intended to limit the present application thereto. Those skilled in the art may utilize other appropriate methods to implement spatial neighborhood merging within the scope of the present application.

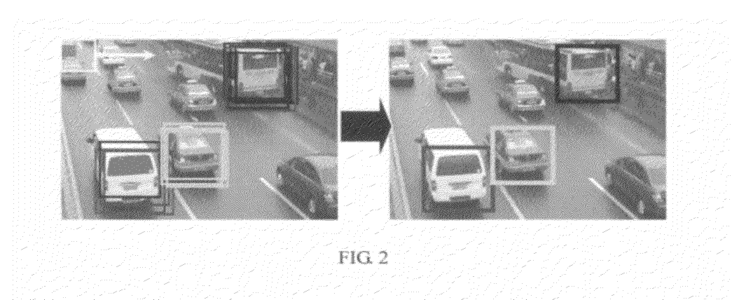

FIG. 2 illustrates an example graph of the spatial neighborhood merging processing in the spatial neighborhood merging step S130, in which the merged region described above is represented by a bold frame in the right drawing.

Return back to FIG. 1, next, in the judgment step S140, it is judged whether the object detection confidence of the merged region is higher than a predetermined threshold for each merged region.

Next, in the merged confidence calculation step S150, if the object detection confidence of the merged region is higher than the predetermined threshold, then for each class, a merged object classification confidence is calculated for all the windows with positive result of object existence decision within the merged region.

The calculation of the merged object classification confidence may be performed in various ways in the merged confidence calculation step S150. For example, a sum or an average of the object classification confidences of respective windows with positive result of object existence decision is calculated; or each object classification confidence is normalized and the normalized object classification confidences are summed or averaged; and the like. It shall be appreciated that the method for calculating the merged object classification confidence described herein is merely exemplary, but not intended to limit the present application thereto. Those skilled in the art may utilize other appropriate calculation methods (for example construction of a histogram and the like) to calculate the merged object classification confidence within the scope of the present application.

Finally, in the class determination step S160, the class with the highest merged object classification confidence is determined as the class of the merged region.

The object detection and classification method according to the embodiment of the invention has been described above in combination with the accompanying drawings. An object detection and classification apparatus according to an embodiment of the invention will be described in combination with the accompanying drawings below.

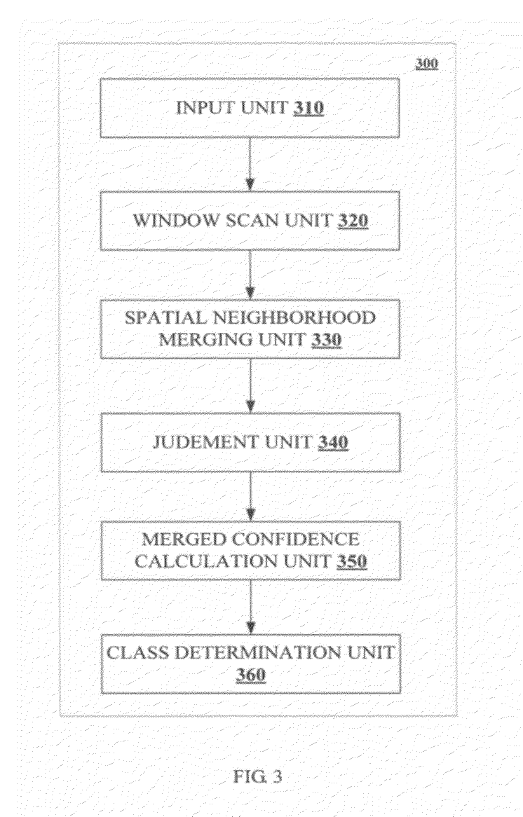

FIG. 3 illustrates a structural block diagram of the object detection and classification apparatus 300 according to an embodiment of the invention, in which only those parts closely relevant to the present invention are shown for the sake of conciseness. The object detection and classification method described above with reference to FIG. 1 can be performed in the object detection and classification apparatus 300.

As shown in FIG. 3, the object detection and classification apparatus 300 may include an input unit 310, a window scan unit 320, a spatial neighborhood merging unit 330, a judgment unit 340, a merged confidence calculation unit 350 and a class determination unit 360.

The input unit 310 may be configured to input an image to be processed; the window scan unit 320 may be configured to perform window scan on the image to make, for each class, object existence decision of whether an object of this class exists on each window, and then make, on a window of which the decision is positive, an object class decision of whether this window is of this class or other classes, so as to obtain an object classification confidence of the window with respect to this class; the spatial neighborhood merging unit 330 may be configured to perform, for all classes, spatial neighborhood merging on all windows with positive result of object existence decision to obtain one or more merged regions and object detection confidences thereof; the judgment unit 340 may be configured to judge, for each merged region, whether the object detection confidence of the merged region is higher than a predetermined threshold; the merged confidence calculation unit 350 may be configured to calculate, for each class, a merged object classification confidence for all the windows with positive result of object existence decision within the merged region, if the object detection confidence of the merged region is higher than the predetermined threshold; and the class determination unit 360 may be configured to determine a class with a highest merged object classification confidence as the class of the merged region.

How the functions of respective constituting units of the object detection and classification apparatus 300 can be implemented will become clear through reading the description of corresponding processes given above, thus the details of which are omitted herein.

It shall be noted herein that the structures of the object detection and classification apparatus 300 and its constituting units as shown in FIG. 3 are merely exemplary, and those skilled in the art may make modifications to the structural block diagram as shown in FIG. 3 as required.

The basic principles of the present invention have been described in combination with specific embodiments above, however, it shall be noted that for those skilled in the art, it can be understood that all or any step or component of the method and apparatus of the present invention may be implemented by hardware, firmware, software or combinations thereof in any computing apparatus (including a processor, a storage medium and the like) or a network of computing apparatuses, which can be realized by those skilled in the art by utilizing their basic programming skills after reading the description of the invention.

Therefore, the object of the present invention may also be achieved by running a program or a set of programs on any computing apparatuses. The computing apparatuses may be well-known general-purpose apparatuses. Therefore, the object of the present invention may also be achieved simply by providing a program product containing program codes implementing the method or apparatus. That is, such a program product constitutes the present invention, and also a storage medium storing such a program product constitutes the present invention. Obviously, the storage medium may be any well-known storage medium or any storage medium to be developed in the future.

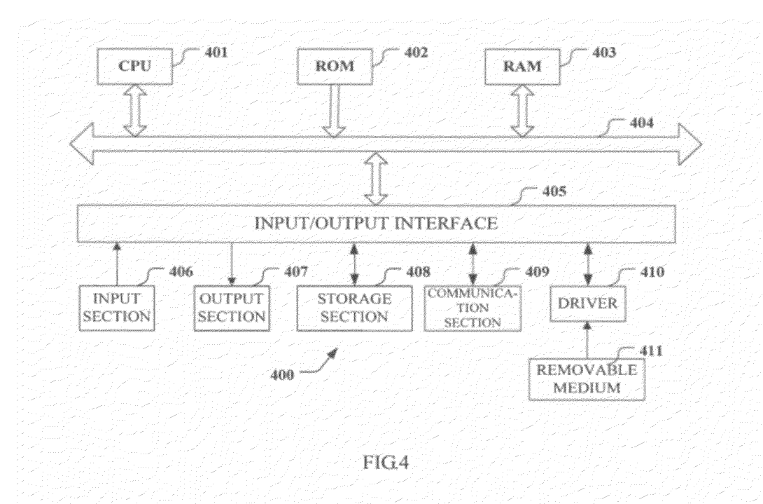

In a case that the embodiments of the invention are implemented by software and/or firmware, the programs constituting the software are installed from a storage medium or a network into a computer with a dedicated hardware structure (for example, a general-purpose computer 400 as shown in FIG. 4), which is capable of carrying out various functions and the like when installed with various programs.

In FIG. 4, a central processing unit (CPU) 401 executes various processes in accordance with a program stored in a read only memory (ROM) 402 or a program loaded into a random access memory (RAM) 403 from a storage section 408. Data required for the CPU 401 to execute the various processes and the like is also stored in RAM 403 as required. The CPU 401, the ROM 402 and the RAM 403 are connected to one another via a bus 404. An input/output interface 405 is also connected to the bus 404.

The following components are connected to the input/output interface 405: an input section 406 including a keyboard, a mouse and the like; an output section 407 including a display such as a cathode ray tube (CRT) display, a liquid crystal display (LCD) and the like, and a speaker and the like; the storage section 408 including hard disk and the like; and a communication section 409 including a network interface card such as a LAN card, a modem or the like. The communication section 409 performs a communication via the network such as Internet.

A driver 410 is also connected to the input/output interface 405 as required. A removable medium 411, such as a magnetic disk, an optical disk, a magneto optical disk, a semiconductor memory or the like, is mounted onto the driver 410 as required, so that the computer program read therefrom is installed into the storage section 408 as required.

In a case that the above series of processes are implemented by software, the program constituting the software is installed from a network such as Internet or a storage medium such as the removable medium 411.

Those skilled in the art shall understand that this storage medium is not limited to the removable medium 411 in which a program is stored and which is distributed separately from the apparatus so as to provide the program to the user as shown in FIG. 4. Examples of the removable medium 411 include the magnetic disk (including floppy disk (registered trade mark)), the optical disk (including compact disk-read only memory (CD-ROM) and digital versatile disk (DVD)), the magneto optical disk (including mini disk (MD) (registered trade mark)) and the semiconductor memory. Alternatively, the storage medium may be the ROM 402, the hard disk contained in the storage section 408 or the like, in which a program is stored and which is distributed to the user together with the apparatus containing it.

It shall also be noted that obviously each component or each step may be decomposed and/or recombined in the apparatus and method of the present invention. These decompositions and/or re-combinations shall be considered as equivalent schemes of the present invention. Also, the steps of performing the above series of processes may be naturally performed chronologically in an order of description but not necessarily. Some steps may be performed in parallel or independently from one another.

Although the invention and advantages thereof have been described in detail herein, it shall be understood that various changes, replacements and modifications may be made by one skilled in the art without departing from the spirit and scope of the invention. Furthermore, the terms “comprise”, “include” or any other variation thereof are intended to cover a non-exclusive inclusion, so that a process, method, article, or apparatus that comprises a list of elements includes not only those elements but also other elements not explicitly listed or inherent to such process, method, article, or apparatus. Unless further defined, a sentence “comprises a/an . . . ” which defines an element does not preclude the existence of additional identical element(s) in the process, method, article, or apparatus that comprises the element.

What is claimed is:

1. An object detection and classification method, comprising:
inputting an image to be processed;
performing window scan on the image to make, for each class, an object existence decision of whether an object of this class exists in each window, and then making, on a window of which the object existence decision is positive, an object class decision of whether the window is of this class or other classes, so as to obtain an object classification confidence of the window with respect to this class;
performing, for all classes, spatial neighborhood merging on all windows with positive result of object existence decision to obtain one or more merged regions and object detection confidences thereof;
judging, for each merged region, whether the object detection confidence of the merged region is higher than a predetermined threshold;
calculating, for each class, a merged object classification confidence for all the windows with positive result of object existence decision within the merged region, if the object detection confidence of the merged region is higher than the predetermined threshold; and
determining a class with a highest merged object classification confidence as the class of the merged region.

2. The object detection and classification method as claimed in claim 1, wherein performing window scan on the image comprises performing multi-scale window scan on the image.

3. The object detection and classification method as claimed in claim 1, wherein performing spatial neighborhood merging on all windows with positive result of object existence decision is implemented through clustering processing.

4. The object detection and classification method as claimed in claim 1, wherein in making the object class decision on the window of which the object existence decision is positive, a previous detection result is not rejected if the window is not of the current class according to the object class decision.

5. The object detection and classification method as claimed in claim 1, wherein calculating the merged object classification confidence for all the windows with positive result of object existence decision within the merged region comprises calculating a sum or an average of the object classification confidences of respective windows with positive result of object existence decision within the merged region.

6. The object detection and classification method as claimed in claim 1, wherein calculating the merged object classification confidence for all the windows with positive result of object existence decision within the merged region comprises:
normalizing the object classification confidences of respective widows with positive result of object existence decision within the merged region; and
summing or averaging the normalized object classification confidences as the merged object classification confidence.

7. The object detection and classification method as claimed in claim 1, wherein calculating the merged object classification confidence for all the windows with positive result of object existence decision within the merged region comprises: constructing a histogram in accordance with the object classification confidences of respective windows with positive result of object existence decision within the merged region with respect to each class.

8. An object detection and classification apparatus, comprising:
an input unit configured to input an image to be processed;
a window scan unit configured to perform window scan on the image to make, for each class, an object existence decision of whether an object of this class exists in each window, and then make, on a window of which the object existence decision is positive, an object class decision of whether the window is of this class or other classes, so as to obtain an object classification confidence of the window with respect to this class;
a spatial neighborhood merging unit configured to perform, for all classes, spatial neighborhood merging on all windows with positive result of object existence decision to obtain one or more merged regions and object detection confidences thereof;
a judgment unit configured to judge, for each merged region, whether the object detection confidence of the merged region is higher than a predetermined threshold;
a merged confidence calculation unit configured to calculate, for each class, a merged object classification confidence for all the windows with positive result of object existence decision within the merged region, if the object detection confidence of the merged region is higher than the predetermined threshold; and
a class determination unit configured to determine a class with a highest merged object classification confidence as the class of the merged region.

9. The object detection and classification apparatus as claimed in claim 8, wherein the window scan unit performs multi-scale window scan on the image.

10. The object detection and classification apparatus as claimed in claim 8, wherein the spatial neighborhood merging unit performs spatial neighborhood merging on all the windows with positive result of object existence decision through clustering processing.

11. The object detection and classification apparatus as claimed in claim 8, wherein when the window scan unit makes the object class decision on the window of which the object existence decision is positive, a previous detection result is not rejected if the window is not of the current class according to the object class decision.

12. The object detection and classification apparatus as claimed in claim 8, wherein the merged confidence calculation unit calculates the merged object classification confidence for all the windows with positive result of object existence decision within the merged region by calculating a sum or an average of the object classification confidences of respective windows with positive result of object existence decision within the merged region.

13. The object detection and classification apparatus as claimed in claim 8, wherein the merged confidence calculation unit calculates the merged object classification confidence for all the windows with positive result of object existence decision within the merged region by the following processes:
normalizing the object classification confidences of respective widows with positive result of object existence decision within the merged region; and
summing or averaging the normalized object classification confidences as the merged object classification confidence.

14. The object detection and classification apparatus as claimed in claim 8, wherein the merged confidence calculation unit calculates the merged object classification confidence for all the windows with positive result of object existence decision within the merged region by constructing a histogram in accordance with the object classification confidences of respective windows with positive result of object existence decision within the merged region with respect to each class.

15. A program product with machine readable instruction codes stored thereon, which, when being read and executed by a machine, performs an object detection and classification method, wherein the object detection and classification method comprises steps of:
inputting an image to be processed;
performing window scan on the image to make, for each class, an object existence decision of whether an object of this class exists in each window, and then making, on a window of which the object existence decision is positive, an object class decision of whether the window is of this class or other classes, so as to obtain an object classification confidence of the window with respect to this class;
performing, for all classes, spatial neighborhood merging on all windows with positive result of object existence decision to obtain one or more merged regions and object detection confidences thereof;
judging, for each merged region, whether the object detection confidence of the merged region is higher than a predetermined threshold;
calculating, for each class, a merged object classification confidence for all the windows with positive result of object existence decision within the merged region, if the object detection confidence of the merged region is higher than the predetermined threshold; and
determining a class with a highest merged object classification confidence as the class of the merged region.

16. A storage medium carrying thereon the program product according to claim 15.
